(19) United States
(12) Patent Application Publication
(10) Pub. No.: US 2011/0298885 A1
(43) Pub. Date: Dec. 8, 2011

(54) REMOTE PRESENCE ROBOTIC APPARATUS

(75) Inventor: TIMOTHY ROOT, Nashua, NH (US)

(73) Assignee: VGO Communications, Inc., Nashua, NH (US)

(21) Appl. No.: 12/793,146

(22) Filed: Jun. 3, 2010

(51) Int. Cl. H04N 7/15

(52) U.S. Cl. 348/14.1; 348/E07.083; 901/50

(57) ABSTRACT

A mobile robotic device includes functionality that enables it to support an audio/video conference session. The mobile robotic device includes an upper body section and a lower body section. The upper body section is comprised of one or more microphones and speakers and a display with the speakers being proximate to the display. The lower body section is comprised of a base that can include the audio and video processing electronics, one or more speakers and means for propelling the robotic device in its environment. The range of frequencies played by the speakers in the upper section and the range of frequencies played by the speakers in the lower section are distributed such that the source of the sound appears to come from the upper section proximate to the display.

### FIELD OF INVENTION

The invention relates generally to the area of robotic devices that include interpersonal communication capability and specifically to robotic devices that include the capability to play high quality audio received from a remote location or generated locally.

### BACKGROUND

Mobile robotic devices are currently available that provide services previously only provided by communications devices such as mobile phones dedicated to audio communication, video and/or audio conferencing applications such as mobile phones, audio and/or video conferencing systems and the like. Mobile robotic devices that include such communications applications are typically referred to as tele-presence or remote presence robotic systems. Remote presence robotic systems can be used for interpersonal communication; however, unlike audio and video conference systems, which are stationary devices, remote presence robots can be mobile and capable of following an individual as they move around their environment.

U.S. Pat. No. 7,218,992 describes, with reference to FIGS. 1 and 2 and the corresponding description in columns 2 and 3, a mobile robotic device that includes a camera 38, LCD display 40, a single speaker 44 and microphone 42 and the necessary audio and video processing and communication functionality to communicate over a network with a remote communication device.

U.S. patent application Ser. No. 11/541,422 generally describes a mobile robotic device for interacting with an individual proximate to the device and with a remote communication device. With reference to FIG. 1A and the corresponding description on page 10 starting in paragraph [0103], the mobile robotic device is described as including a single speaker 20, microphone array 305, display 26 and functional systems for communications.

One important aspect of a communication session is the fidelity or the quality with which the remote audio is played by a local communication device. Audio and/or video conferencing systems can include expensive speaker systems with multiple speakers that cover the entire audible frequency range. Such high fidelity speaker systems are practical in tele or video conferencing system because the systems are not intended to be portable, so the speakers can be strategically placed in the environment to maximize the quality of the remote audio being played. On the other hand, mobile communication devices, such as smart phone for instance, typically do not have the capability to play high quality remote audio, as the speaker or speakers necessarily need to be small in order to fit within the form factor of a mobile communications device. Typically, high quality audio speaker systems employ separate speakers specifically designed to play different portions of the audio frequency spectrum. So for instance, one speaker in an audio system can be used to play the bass range, which can start at 100 Hz and run to 2 KHz, and another speaker can be used to play either or both of mid-range and hi-range frequencies which can start at 1 KHz and run up past 16 KHz.

An important consideration when designing audio and/or video conferencing systems is the placement of the speakers with respect to the system microphones. Due to the relatively higher sound energy levels associated with bass frequencies and the need to minimize feedback into the microphones, speakers that reproduce sound in the bass range need to be positioned at a greater distance from the microphones than the speakers that reproduce mid-range and hi-frequency audio.

Remote presence robotic devices are typically designed to accommodate the interaction between two remote individuals. The individuals can be sitting or standing or moving around in their environment. Regardless, in order to accommodate high quality communication sessions between remote individuals, these robotic devices are typically designed so that they are vertically elongated or their vertical dimension is larger than their horizontal dimension, with the vertical dimension being large enough such that the microphones, display and speakers can be positioned on the robotic device 10 for optimal interaction with the individual using the robotic device for communications. The vertical dimension is typically large enough so that the voice of the individual is easily detected by the microphones on the robot and so that the individual using the robot can comfortably observe or touch a display included on the robot. In general, a remote presence robotic device is designed to optimize the quality of the interpersonal communications experience.

Typically, the speaker or speakers included in remote presence robotic devices are full-range speakers and are positioned on the robotic device to minimize any audio feedback to the microphones. So for instance, if the microphones are located in the upper portion of the robotic device, the speaker(s) are located towards the middle or lower portion of the robotic device and vice versa. Also, depending upon the weight of the robotic device and its center of gravity, it is not prudent to place a relatively heavy bass speaker toward the upper portion of the device, as this can result in instability while the robotic device is moving around its environment.

### SUMMARY

It was discovered that a remote presence robotic device providing a hi-quality interpersonal communication experience can be designed with a display, microphones and mid-range to hi-range speakers located in the upper portion of the device and with a bass range speaker located below the upper portion of the device such that substantially all of the sound played by the speakers appears to come from the upper portion of the robotic device. Further, the inclusion of a separate bass range speaker on the robotic device results in a higher quality audio communications session and the position of the relatively heavier bass range speaker in the lower portion of the robotic device tends to lower the center of gravity of the device thereby making it more stable during movement. Further, it was discovered that equalizing the sound energy between the bass and mid-range and hi-frequency speakers mitigates the audio feed back into the microphones and results in the sound played by the robotic device speakers to appear as though it comes from the upper portion of the device.

### BRIEF DESCRIPTION OF DRAWINGS

FIG. 1 is a diagram of a remote presence robotic device showing a bass speaker in the lower portion of the robotic device.

FIG. 2 is a diagram of the remote presence robotic device showing the bass speaker in the middle portion of the robotic device.

FIG. 3 is a block diagram showing the functionality necessary to enable the remote presence functionality included in the robotic device.

### DETAILED DESCRIPTION

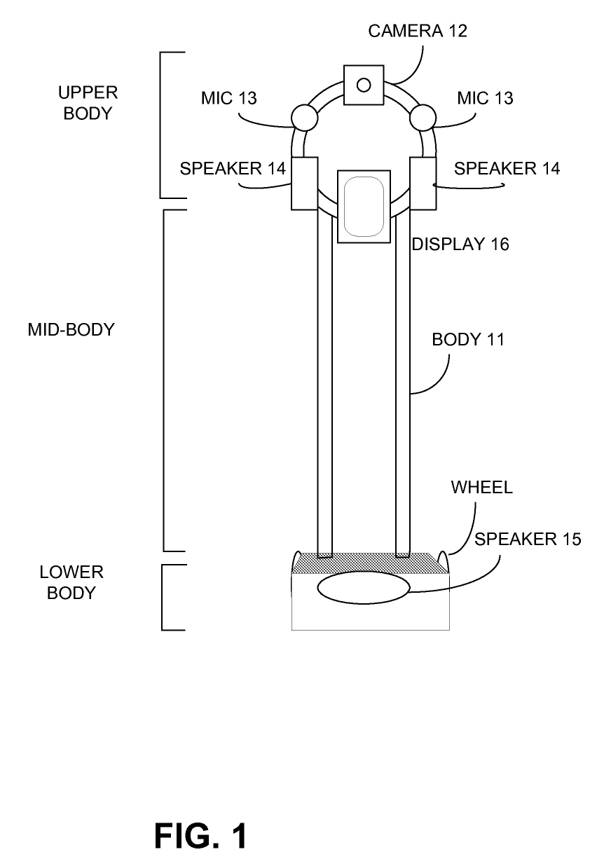

The remote presence robotic device 10 of FIG. 1 includes a plurality of drive wheels, the rotation of which is either autonomous, based on information received by sensors included on the robotic device, or the rotation of which can be remotely controlled by an individual/user with access to the robotic device motion controls or the robotic device can be autonomous with motion control signal being received by environmental sensors mounted on the robotic device. The robotic device 10 includes a body 11 that can be made of a plastic or a composition material that is both light in weight and durable. The body 11 includes an upper portion 17 that is comprised of at least one camera 12, one or more microphones 13, one or more speakers 14 (mid-range/tweeter in combination or as discrete speakers) with a frequency response in the 250 Hz to 17 KHz or higher and a display 16. The body 11 also includes a middle portion 18 that includes that portion of the body 10 that lies between the upper portion 17 and a lower portion 19. In FIG. 1, the middle portion 18 of the robotic device body 11 does not include any functionality that directly contributes to the communication functionality of the robotic device 10 but can include a mid-range speaker. The lower portion 19, among other things, includes a mid-range/bass speaker or bass speaker 15 with a frequency response in the 100 Hz to 12 KHz frequency range. In one embodiment, the robotic device 10 is comprised of only an upper and a lower portion. The frequency response ranges of the combination mid-range tweeter speaker(s) and/or the mid-range/bass speaker included in the body 10 are not limited to the frequency ranges described above and can start and/or end at lower or higher frequencies resulting in a smaller or larger frequency response range. Generally, sound generated by speakers in the 2 KHz and greater frequency range is directional while sound generated by speakers in the frequency range that is less than 300 Hz is not, so in order to implement a robotic device 10 in which the sound appears to originate from the upper portion of the device, it is important to include a speaker that plays sound in the highest frequency range, the tweeter/mid-range speaker in this case, as close to the upper portion of the robotic device 10 as possible,

The camera 12 mounted on the robotic device 10 of FIG. 1 can be employed to capture frames that represent either moving or still images in its environment, and the frames can be processed and transmitted over a network to a remote location for display. The one or more microphones 13 serve to receive sound energy information from the robotic devices environment (i.e., voice) which can also be processed in various ways and then transmitted over the network for playback at a remote location. The display 16 is suitable for displaying either video or still images or characters and can be employed to display some portion (i.e., the face) of a remote individual with which a local individual is communicating. The speakers 14 and 15 are used to play audio received over the network from a remote location and this audio is typically remote audio received by the robotic device 10 over the network.

The vertical dimension of the body 11 is greater than the horizontal dimension of the body 11, such that the robotic device 10 exhibits an upright as opposed to reclining appearance. The vertical dimension is large enough so that an individual, local to the robotic device 10, can use the device to effectively communicate with a remote individual who may or may not also be using a similar device and the horizontal dimension is small enough to permit the device 10 to easily move around in its environment. Effective communication in this case means that the camera 12 is positioned high enough on the robotic device 10 so that the far end video or image does not give the viewer of these images the appearance that the robotic device 10 is looking up at an extreme angle (i.e., at an angle that is not comfortable for an individual to elevate their head in order to converse with someone), that the microphones are close enough to the sound source to receive a strong audio signal, that the display is high enough for the individual at the near end to comfortable view images on the screen, and that the mid-range/tweeter combination speakers are close enough to the display so that is appears that the sound is coming from the display 16 located in the upper portion of the robotic device 10.

In operation, an individual proximate to the robotic device 10 can initiate and participate in a communication session, with a remote individual, while moving around their environment. Either the robotic device 10 is capable of autonomously following the individual around or the remote individual participating in the communication session can control the robotic device to follow the individual around, in either case the communication session, whether it is only audio or both audio and video, is very natural and of very high audio quality. In addition to positioning the mid-range/bass speaker in the lower portion of the robotic device 10 to improve the fidelity of the audio, another consideration when positioning the bass speaker 15 on the body 11 of the robotic device 10, is to maximize the distance between the bass speaker 15 and the microphone(s). Sound energy in the mid-range/bass frequency range is of higher energy than sound in the mid-range or tweeter ranges and so there is more acoustic coupling between the microphones and the sound played by the speakers in this range than there is with the sound played by the speakers in the higher frequency ranges. Although the robotic device 10 does include audio processing functionality that can suppress or cancel this acoustic feedback, positioning the speaker 15 in the lower portion of the robotic device 10 such that it is close to the surface over which the device travels maximizes the effect of the bass frequencies for the listener while preventing the suppression and echo cancellation functionality from being overwhelmed. Yet another consideration for positioning the mid-range/bass speaker in the lower portion of the robotic device 10 is that of weight distribution for the stability of the device 10. Bass speakers tend to be heavy and placing the bass speaker in the base of the lower portion of the robotic device 10 gives the device a lower center of gravity which results in more stability particularly when the device is moving around in its environment.

With further reference to FIG. 1, the source of the remote audio playback can be tuned by equalizing the lower frequencies with respect to the higher frequencies. This source tuning can be accomplished by speaker selection, by applying more or less power to different speakers, or using digital signal processing techniques to modify the frequency spectrum, or electronically with analog circuit components.

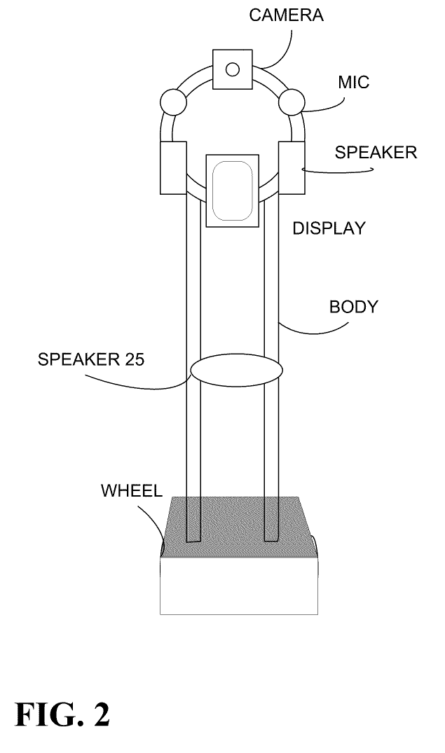

FIG. 2 is a diagram of a remote presence robotic device 20 that is similar to the robotic device 10 of FIG. 1. The only difference between the robotic device in FIG. 1 and the robotic device in FIG. 2 is that a mid-range/bass speaker 25 is included in the middle portion of a robotic device 20 in FIG. 2. Although, for all of the reasons described earlier with reference to FIG. 1, it is more desirable that this speaker be positioned in the lower portion 19 of the robotic device 10, it may be necessary, and it is certainly possible, to position this speaker 25 in the middle portion of the robotic device as well.

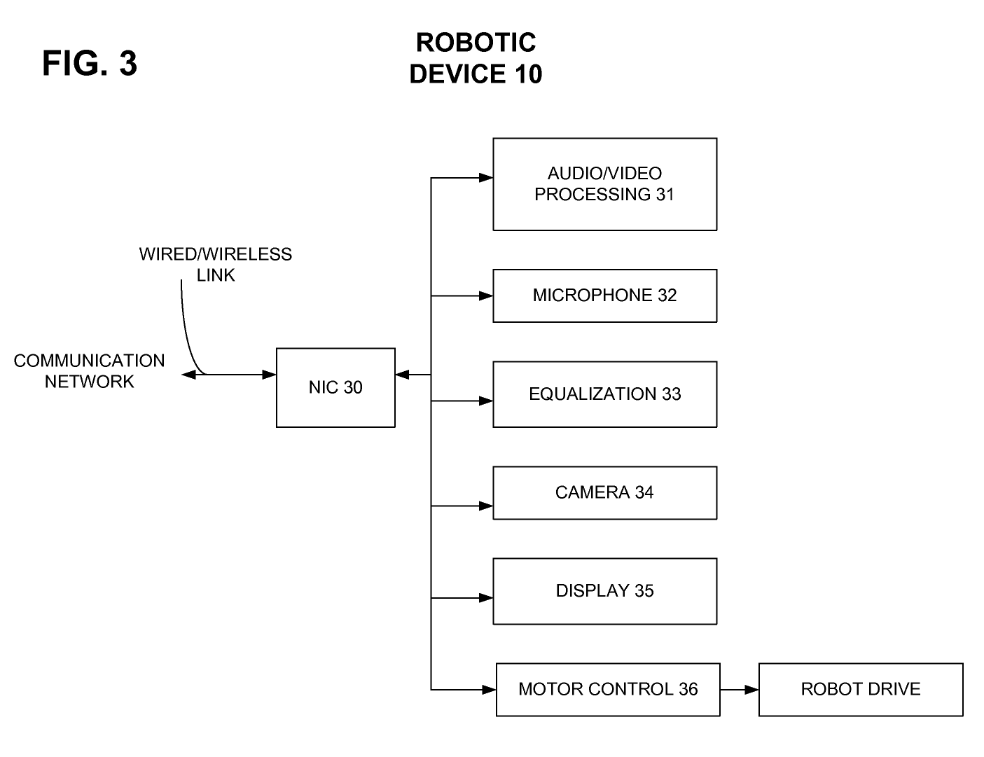

FIG. 3 is a diagram that includes the functional blocks necessary to implement the remote presence robotic device described with reference to FIGS. 1 and 2. The robotic device 10 includes a network interface 30, audio/video processing 31, one or more microphones 32, audio equalization and/or gain control 33 and speakers 33a and 33b, at least one camera 34, a display 35 and motion control 36 and an associated robotic drive 37. The network interface 30 operates to send and receive information, in the form of packets or frames for instance, to and from a communications network to which it is associated. The network interface 30 can be a wireless interface or a wired interface and the information it transmits is, among other things, audio and/or video information received by the robotic device 10 from the local environment in which it operates and the information it receives is, among other things, audio and/or video information transmitted by a remote communications device. The audio and/or video processing functionality 31 can include software or firmware that operates to transform audio and/or video information into a format for transmission specified by the H.32X protocol or some other transmission protocol. The video information can be formatted for transmission according to the H.26X protocol while audio information can be formatted for transmission according to the G.7XX protocol. The processing block 31 can also include analog to digital conversion functionality, audio and/or video compression functionality, acoustic echo cancellation functionality, sound suppression functionality and general session initiation and management functionality such as SIP and. The design and operation of the functionality included in the audio and/or video processing block 31 is well known to audio and video engineers and so will not be described here in any detail.

Continuing to refer to FIG. 3, one or more microphones are placed on the robotic device 10 and operate to receive sound energy information from the robotic devices local environment. If more than one microphone is place on the robotic device, they can be strategically arranged in an array in order to receive sound energy information in a 360° radius around the robotic device. The sound energy received by the microphone(s) can be sent to the audio and/or video processing block 31 for processing and formatting prior to being transmitted over the communications network to a far-end communications device. The audio equalization and gain control functionality 33 operates to balance the power delivered to the speakers 33A and 33B over particular bands of the audible frequency spectrum. In this case, speakers 33A are upper range or mid-range/tweeter type speakers and speaker(s) 33B are lower range or mid-range/bass type speakers. An audio engineer can program or design the equalization functionality so that the mid-range/bass speaker only receives enough power to generate audible sound which serves to optimize the audio fidelity of the sound generated by the robotic device 10, but not enough power so that it overwhelms the AEC functionalities ability to cancel any of the mid-range/bass frequencies picked up by the microphones 32. The camera 34 operates to capture frames of image information and is positioned in the upper portion of the robotic device 10 so that its tilt angle is not uncomfortably large when it focuses on the head of an individual who is speaking in the robotic devices direction. Uncomfortably large in this context means that the camera tilt angle is not so large that robotic device 10 does not have to look up at the individual at an uncomfortable angle). The motivation for positioning the camera in the upper portion of the robotic device is to lower the pan angle necessary to capture the head or face of an individual speaking to the robotic device.

The display 35 in FIG. 3 can be any type of display capable of displaying either still or video images as well as displaying characters or icons. The motivation for positioning the display in the upper portion of the robotic device body 11 is to optimize the interpersonal communication experience of the individual speaking to the robotic device by allowing the individual to easily focus their attention on the face of the remote individual. Further, the motivation for positioning the speakers 33A proximate to the display 35 is to simulate a natural communication experience, as if the robotic device 10 is the remote individual that the local individual is communicating with. In other words, the interpersonal communication experience, between an individual local to the robotic device 10 and an individual remote to the robotic device 10 is optimized (i.e., aids in focusing attention on the face of the remote person) if it appears that the sound of the remote individuals voice is coming from the face of the remote individual, as it appears on the display 16 of FIG. 1, as opposed to the middle portion 18 or lower portion 19 of the robotic device body 11. Additionally, as described earlier with reference to FIG. 1, the addition of a bass speaker in the lower portion of the robotic device results in higher quality sound which also optimizes the interpersonal communications experience.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A robotic device, comprising:
a body with an upper portion and a lower portion;
a network interface for receiving audio and video information;
audio and video signal processing functionality;
a display positioned in the upper portion of the robotic device for displaying the video information; and
a first speaker positioned in the upper portion of the robotic device body proximate to the display and a second speaker positioned in the lower portion of the mobile robotic device body, wherein the frequency ranges played by the first speaker and the second speaker are distributed between the first and second speakers such that the source of the sound appears to be located in the upper portion of the robotic device proximate to the display.

2. The robotic device of claim 1, further comprising means for controlling the distribution of frequencies played by the first and the second speakers.

3. The robotic device of claim 2, wherein the means for controlling the distribution of frequencies is one of electronic equalization, speaker selection and sound amplitude control.

4. The robotic device of claim 1, wherein the first speaker plays sound in a higher frequency range than the second speaker.

5. The robotic device of claim 1, wherein the first speaker plays sound in the mid-range to tweeter frequency range and the second speaker plays sound in the mid-range to bass frequency range.

6. The robotic device of claim 1, wherein the body of the robotic device is elongated in the vertical dimension.

7. The robotic device of claim 1, wherein the upper portion of the robotic device body substantially comprises the top half of the robotic device and the lower portion of the robotic device body substantially comprises the bottom half of the robotic device.

8. The robotic device of claim 1, wherein the first speaker is comprised of two or more separate speakers.

9. The robotic device of claim 1, wherein the second speaker is comprised of two or more separate speakers.

10. A robotic device, comprising:
a body with an upper portion, a middle, and a lower portion;
a network interface for receiving audio and video information;
audio and video signal processing functionality;
a display positioned in the upper portion of the robotic device for displaying the video information; and
a first speaker positioned in the upper portion of the robotic device body proximate to the display and a second speaker positioned in the middle portion of the mobile robotic device body, wherein the frequency ranges played by the first speaker and the second speaker are distributed between the first and second speakers such that the source of the sound appears to be located in the upper portion of the robotic device proximate to the display.

11. The robotic device of claim 10, further comprising means for controlling the distribution of frequencies played by the first and the second speakers.

12. The robotic device of claim 11, wherein the means for controlling the distribution of frequencies is one of electronic equalization, speaker selection and sound amplitude control.

13. The robotic device of claim 10, wherein the first speaker plays sound in a higher frequency range than the second speaker.

14. The robotic device of claim 10, wherein the first speaker plays sound in the mid-range to tweeter frequency range and the second speaker plays sound in the mid-range to bass frequency range.

15. The robotic device of claim 10, wherein the body of the robotic device is elongated in the vertical dimension.

16. The robotic device of claim 10, wherein the upper portion of the robotic device body substantially comprises the top one-third of the robotic device and the middle portion of the robotic device body substantially comprises the middle one-third of the robotic device.

17. The robotic device of claim 10, wherein the first speaker is comprised of two or more separate speakers.

18. The robotic device of claim 10, wherein the second speaker is comprised of two or more separate speakers.

19. A robotic device, comprising:
a body with an upper portion, a middle, and a lower portion;
a network interface for receiving audio and video information;
audio and video signal processing functionality;
a display positioned in the upper portion of the robotic device for displaying the video information; and
a first speaker positioned in the upper portion of the robotic device body proximate to the display, a second speaker positioned in the middle portion of the mobile robotic device body and a third speaker positioned in the lower portion of the mobile robotic device body, wherein the frequency ranges played by the first speaker, the second speaker and the third speaker are distributed between all of the speakers such that the source of the sound appears to be located in the upper portion of the robotic device proximate to the display.

20. The robotic device of claim 19, wherein the first speaker plays sound in the tweeter frequency range, the second speaker plays sound in the mid-frequency range and the third speaker plays sound in the bass frequency range.
